(19) United States
(12) Patent Application Publication
(10) Pub. No.: US 2025/0371427 A1
(43) Pub. Date: Dec. 4, 2025

(54) METHODS AND SYSTEMS FOR IMPROVED AUTOMATED MACHINE LEARNING AND DATA ANALYSIS

(71) Applicant: QlikTech International AB, Lund (SE)

(72) Inventors: Sudhamsh Reddy, King of Prussia, PA (US); Steven Pressland, Borough Green (GB)

(21) Appl. No.: 19/226,388

(22) Filed: Jun. 3, 2025

Related U.S. Application Data
(60) Provisional application No. 63/655,217, filed on Jun. 3, 2024.

(51) Int. Cl. G06N 20/00

(52) U.S. Cl. CPC G06N 20/00

(57) ABSTRACT

The disclosed methods and systems automate the process of building machine learning models. A user interface receives a selection of a dataset for a machine learning experiment. An execution plan for the experiment is determined based on the selected dataset. The experiment is executed according to the execution plan to generate a plurality of machine learning models. The performance of the generated models is evaluated based on one or more performance metrics. A model is selected from the generated models based on the evaluation of the performance metrics. The selected model may be stored for future use.

### CROSS-REFERENCE TO RELATED PATENT APPLICATION

This application claims priority to U.S. Prov. App. No. 63/655,217, filed on Jun. 3, 2024, the entirety of which is incorporated by reference herein.

### BACKGROUND

Machine learning (ML) is a subset of artificial intelligence that uses statistical techniques to enable computer systems to learn from data and improve performance without being explicitly programmed. To build predictive models, even experienced data scientists and ML engineers must take several steps. However, these steps take time and not all of them are done in the most efficient manner. These and other considerations are discussed herein.

### SUMMARY

It is to be understood that both the following general description and the following detailed description are exemplary and explanatory only and are not restrictive.

The present disclosure relates to methods and systems for improved automated machine learning (AutoML) and data analysis. The disclosed AutoML system employs an iterative approach to assess and compare the performance of various machine learning algorithms, such as linear-based and tree-based algorithms. During the iterative process, the system evaluates the performance of these algorithms on a given dataset to determine the model that yields the optimum predictive accuracy. The disclosed methods and systems streamline the model selection process, reducing the complexity and expertise typically associated with building, testing, and validating predictive models in machine learning. The disclosed methods and systems incorporate an in-memory data analysis engine that facilitates rapid and efficient analysis of machine learning models. Other examples are possible as well.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1A illustrates an example system.

FIG. 1B illustrates an example system.

FIG. 2 illustrates an example workflow.

FIGS. 3-9 illustrate example dashboards.

FIG. 10A illustrates an example system.

FIG. 10B illustrates a flowchart for an example method.

FIG. 11 illustrates an example system.

FIG. 12 illustrates a flowchart for an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The present disclosure relates to methods and systems for automating the process of building machine learning models. These methods and systems aim to address the challenges and complexities associated with traditional machine learning model development, which often requires a high level of expertise and involves numerous steps, including hypothesis formulation, data collection, data visualization, feature engineering, model training, and hyperparameter tuning. These tasks may be time-consuming and may not be performed in the optimum manner. Furthermore, the process often requires substantial computational resources and may not be scalable for large datasets or various domains.

The disclosed methods and systems aim to automate these tasks, thereby enhancing accessibility, efficiency, scalability, and optimization. The system provides a web interface at a client device to allow a user to configure each experiment. Once configured, the experiment executes according to an execution plan (or a set of execution plans), and results of the execution plan include the machine learning models that are generated or built as part of the experiment. The system supports various algorithms for classification and regression, and it performs feature engineering and preprocessing on each data record within each table of the dataset.

The system may perform exploratory data analysis (EDA) on a target feature(s) associated with the experiment, as well as on the dataset with the target feature(s) considered. After EDA is performed, the system may output to the user interface any indication of detected leakage, data sanity check alerts, and a data profile. The user then configures the experiment via the user interface, and the system executes the experiment according to the execution plan (or the set of execution plans). The system iteratively refines the models by adjusting hyperparameters and feature sets based on the performance metrics. The system also includes an in-memory data analysis engine for analyzing data generated through the experiment. The in-memory data analysis engine extracts the data and provides a user interface to facilitate dynamic display of the data.

The present methods and systems provide several enhancements over existing AutoML methods and systems. One such improvement is the integration of an in-memory data analysis engine, which allows for real-time analysis and visualization of data. This feature enables users to make more informed decisions about model selection and tuning, leading to the creation of more accurate and efficient machine learning models. Additionally, the present methods incorporate advanced feature engineering and preprocessing capabilities, which automate the transformation of raw data into a format that is more suitable for machine learning algorithms. This not only saves time but also ensures that the data is processed in a consistent and optimized manner, reducing the likelihood of errors that could arise from manual data handling. By identifying potential issues early in the process, the system helps to prevent the development of models that could be biased or based on flawed assumptions. The system's iterative refinement of models through hyperparameter adjustments and feature set optimization is another area where the present methods excel. By continuously evaluating model performance and making data-driven adjustments, the system ensures that the final models are finely tuned to deliver the desired outcomes.

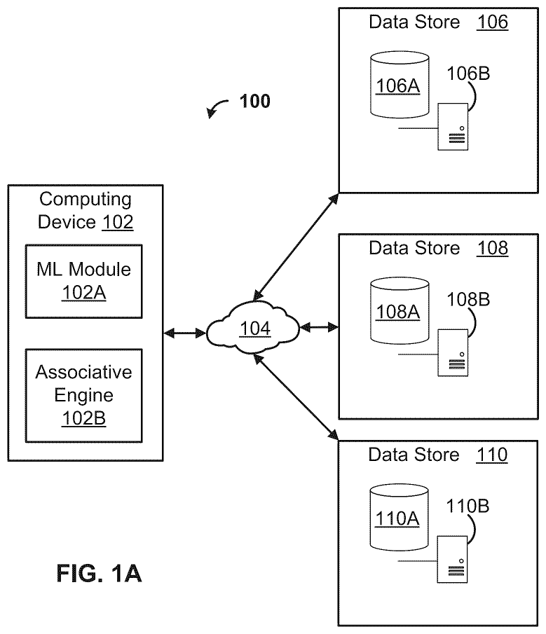

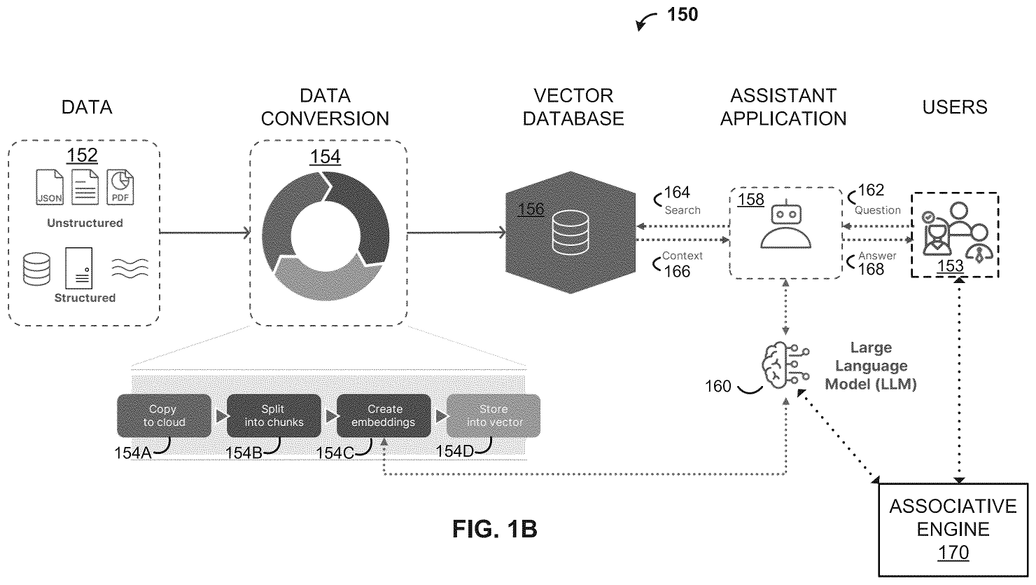

Turning now to FIG. 1A, a block diagram of an example system 100 is shown. The system 100 may include a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. Though the ML module 102A is shown in FIG. 1A as being resident at the computing device 102, it is to be understood that the ML module 102A may be resident at one or more computing devices that may be local or remote to the computing device 102. The computing device 102 may comprise an Associative Engine (AE) module 102B. The AE module 102B may store one or more data models in-memory (e.g., within the primary memory/RAM of the computing device 102) and manage associations between data elements. For example, based on data elements within a data model, the AE module 102B may provide instantaneous calculation of aggregates, selections, and filters as further described herein.

Each of the plurality of data stores 106, 108, 110 may comprise one or more data storage mechanisms, such as a relational database, an in-memory data store, a log, or any other data storage repository configured for a retrieval interface. For case of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some cases, the system 100 may be integrated with other systems or technologies to enhance its functionality. For example, the system 100 may be integrated with a business intelligence platform, a data warehouse, a customer relationship management system, or other types of systems. This integration may allow the system 100 to access additional data, provide more comprehensive insights, or offer additional features to the users.

As an example, turning now to FIG. 1B, an example system 150 is shown. The system 150 may comprise one or more components of the system 100, as further described herein. That is, the capabilities of the system 150 as described herein also apply to the system 100, as the two systems may share—or may each comprise—each described component, resource, device, etc., that performs each of the actions described herein (and potentially not shown).

In some aspects, the system 150 may be utilized to transform data 152 into a format that may be consumed by one or more Large Language Models (LLMs). For example, the data 152 may comprise both structured data and unstructured data. The structured data may be related to one or more analytics “apps” as further described herein, which may include one or more data models, data tables, information regarding connections to various sources such as databases, spreadsheets, and/or web services in an analytics system, etc. The unstructured data may comprise file-based sources, such as presentations, mail archives, text documents, PDFs, transcripts, etc.

The data 152 may be split into manageable chunks in a data conversion process 154. At step 154A, the data 152 may be copied to a cloud-based environment. At step 154B, the data 152 may be split into chunks (e.g., portions of text data). The size of these chunks may vary depending on various factors. For instance, the complexity of the data or the computational resources available may influence the size of the chunks. In some cases, larger chunks may be used if the data is relatively simple and ample computational resources are available. In other cases, smaller chunks may be used if the data is complex or computational resources are limited.

Once the data is split into chunks, each chunk may be converted into an embedding at step 154C. This conversion may be performed by an LLM or another type of machine learning model. Different types of LLMs may be used depending on the specific requirements of the task. For example, transformer-based models, recurrent neural network models, and/or convolutional neural network models may be used. Transformer-based models, such as BERT (Bidirectional Encoder Representations from Transformers), GPT (Generative Pre-trained Transformer), and T5 (Text-to-Text Transfer Transformer), are particularly well-suited for natural language processing tasks. These models use self-attention mechanisms to process input data, allowing them to capture long-range dependencies and contextual information effectively. Recurrent Neural Network (RNN) models, including Long Short-Term Memory (LSTM) and Gated Recurrent Unit (GRU) networks, are designed to handle sequential data. They maintain an internal state that can capture information from previous inputs, making them useful for tasks involving time-series data or text sequences. Convolutional Neural Network (CNN) models, traditionally used for image processing, have also been adapted for text analysis. They can efficiently capture local patterns and hierarchical features in data, which can be beneficial for certain types of text classification or feature extraction tasks.

In addition to these LLMs, other machine learning models may be employed for creating embeddings. That is, in some cases, one or more other machine learning models that are not LLMs may be used to convert the chunks into embeddings. For case of explanation, however, these one or more other machine learning LLMs that may be used will be referred to as one or more LLMs. For instance, traditional word embedding models like Word2Vec, GloVe (Global Vectors for Word Representation), or FastText can be used to generate vector representations of words or phrases. Dimensionality reduction techniques such as Principal Component Analysis (PCA) or t-SNE (t-Distributed Stochastic Neighbor Embedding) can also be applied to create lower-dimensional embeddings of high-dimensional data. The choice of model depends on factors such as the nature of the data (e.g., text, numerical, categorical), the specific requirements of the task (e.g., accuracy, processing speed, interpretability), and the available computational resources. In some cases, a combination of different models may be used to combine their respective strengths and create more robust or versatile embeddings.

In some examples, at step 154C, each chunk may be converted into an embedding via LLM 160 in FIG. 1B (e.g., resident at and/or within the control of the ML module 102A). Though FIG. 1B only shows one LLM 160, it is to be understood that the system 150 may comprise multiple LLMs 160, such as a primary LLM and a secondary LLM as further described herein. Each embedding may comprise a numerical representation of the corresponding chunk of the data 152 that may be consumed/used by an LLM(s) (e.g., by the LLM 160). At step 154D, the embeddings may be stored in a vector database 156 (e.g., resident at and/or controlled by any of the data stores 106, 108, 110). Additionally, the vector database 156 may store embeddings related to unstructured data, such as presentations, mail archives, text documents, PDFs, transcripts, etc.

The vector database 156 may semantically index the embeddings, which involves organizing the numerical representations of the data chunks in a manner that reflects the semantic meaning of the content within each chunk. This semantic indexing may facilitate more efficient and accurate retrieval of information in response to queries. In some aspects, the semantic indexing may use algorithms that understand the context and relationships between different words and phrases within the embeddings, allowing for a more nuanced search capability. The indexing process may also involve the creation of an index map that correlates the embeddings with their respective data chunks, enabling quick access to the original data when a relevant embedding is identified. Additionally, the vector database 156 may employ techniques such as dimensionality reduction to optimize the storage and retrieval of embeddings without losing the semantic relationships within the data.

After embeddings are generated and semantically indexed in the vector database 156, an assistant application 158 (e.g., resident at and/or controlled by any of the servers 106B, 108B, 110B), such as a natural language (“NL”) assistant and/or a chatbot, may provide answers to queries related to the data 152. For example, such answers may comprise a NL response(s) and/or one or more visualizations as further described herein. The assistant application 158 may interact with the LLM 160 to process natural language queries from one or more users 153. The one or more users 153 may interact with the assistant application 158 via a client device, such as the computing device 102, a mobile device, or a web browser. The assistant application 158 may be designed to provide responses in various formats. In some cases, the assistant application 158 may provide text-based responses. In other cases, the assistant application 158 may provide visual or auditory responses. For example, the assistant application 158 may generate a graphical representation of the response, or it may generate an audio file that verbally communicates the response, a combination thereof, and/or the like.

As shown in FIG. 1B, the one or more users 153 may send a question 162. The question 162 may comprise a NL query, an image, a recording, a combination thereof, and/or the like. The question 162 may be sent to the assistant application 158. The assistant application 158 may perform a search 164 against the vector database 156 in order to receive context 166. The context 166 may be based on the embeddings stored in the vector database 156 (e.g., the data 152), and the context 166 may be used by the assistant application 158 to provide an answer 168 (e.g., a NL answer/output). In this way, the “knowledge” used by the system 150 to provide answers 168 to questions 162 may be based on the data 152, which may form all or part of the basis for the context 166 provided to the assistant application 158. The assistant application 158 may be designed to interact with users 153 in a conversational manner. This may allow for more complex and dynamic interactions between the users 153 and the assistant application 158.

For example, the assistant application 158 may be capable of maintaining a conversation with a user 153 over multiple exchanges, keeping track of the context of the conversation and providing responses that are relevant to the ongoing conversation. In some aspects, the assistant application 158 may be integrated with other systems or applications to provide additional functionality. For example, the assistant application 158 may be integrated with a customer relationship management system, a content management system, a data analysis system, or any other type of system or application. This integration may allow the assistant application 158 to access additional data, utilize additional computational resources, or provide additional services to users.

In analytics systems (e.g., Software as a Service (SaaS) systems), file-based sources that may be used to generate embeddings for the vector database 156 may be contained within one or more “apps” (short for applications). From a technical standpoint, an app in an analytics system such as the system 150 is a self-contained environment designed to facilitate data analysis and visualization. It serves as a comprehensive workspace where the users 153 can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

To create embeddings based on apps for the vector database 156, such as for use processing structured data related to natural language queries, the system 150 may determine and structure a comprehensive set of data and metadata from each corresponding app(s). This data forms the foundation of the structured data embeddings stored in the vector database 156, allowing the system 150 to generate accurate and contextually relevant responses (e.g., answers 168) to queries (e.g., searches 164) submitted by the one or more users 153. The system 150 may aggregate/gather details about the data connections, including information about the data sources connected to the app and any necessary authentication credentials, for example. The system 150 may extract information related to the tables and fields imported into each app, as well as the associations between tables and relevant metadata for each field.

The data load script, which may define how data is imported and transformed, may be captured by the system 150, along with any applied data transformations. Information about the sheets and visualizations within the app, including their layout, types, underlying data, and metadata, may also collected by the system 150. This includes reusable dimensions, measures, and master visualizations defined in the app. The system 150 may also collect the content of any stories or presentations built within the app, including the visualizations and text used, as well as titles, descriptions, and relevant metadata. Additionally, details of saved bookmarks, including selections and filters, may be retrieved by the system 150. If the app uses any custom visualizations or extensions, the system 150 may gather information about these custom objects and their metadata.

Understanding the access permissions and data visibility rules configured in the app is also a part of the system 150's process, so details on user roles and their associated permissions may be included. To ensure the vector database 156 remains current and accurate, the system 150 may periodically capture static data extracts or snapshots of the data used in the app. For example, a purpose-built API(s) may be used by the system 150 to programmatically extract the necessary data and metadata, ensuring that all relevant transformations and calculations are captured. The extracted data may then be organized into a structured format suitable for the vector database 156 by the system 150. Including all relevant metadata provides context and enhances the usability of the vector database 156.

Indexing the vector database 156 supports efficient retrieval of information, and techniques such as vectorization and semantic search, as performed by the vector database 156, enhance the retrieval capabilities for the system 150. Finally, setting up processes to periodically update the vector database 156 with new data and changes from the app ensures the vector database 156 remains current and accurate. By extracting and structuring this comprehensive set of information from an app, the system 150 may create—and maintain—robust knowledge bases corresponding to the structured data, enabling it to provide accurate and contextually relevant answers 168 to user queries/questions 162.

To transform data from an app for use in the system 150, several steps are taken to ensure the data is appropriately structured and accessible for generating accurate and contextually relevant responses. First, data from the app is extracted by the system 150. This includes data from various sources connected to the app, as well as the data model, which comprises tables and their relationships. The data load script and any transformations applied within the app may be replicated by the system 150 to maintain consistency.

Once extracted, the data may be cleaned and preprocessed by the system 150. This may involve handling missing values, normalizing data formats, ensuring that all the transformations applied by the system 150 are consistent, a combination thereof, and/or the like. The goal of data cleaning and preprocessing is to create a structured dataset that the system 150 may easily index and query. The described embeddings, which are dense vector representations of the data, may be created by the system 150, capturing the semantic meaning of textual content.

Text data associated with an app, such as descriptions, titles, and narratives, may be processed using Natural Language Processing (NLP) techniques (e.g., by the LLM 160). For example, models such as BERT, GPT, and/or other transformer-based models may be used by the system 150 to convert the data into embeddings as well (or in the alternative). For structured data, feature vectors representing all numerical attributes and/or categorical attributes within the structured data may be created by the system 150. Techniques like principal component analysis (PCA) and/or use of one or more autoencoders may be used by the system 150 to reduce dimensionality and create embeddings. The embeddings may then be indexed by the vector database 156. This indexing permits efficient similarity searches, enabling the system 150 to quickly retrieve relevant data points based on the query embeddings.

The embedded data forms a knowledge base, which includes indexed embeddings and associated metadata, ensuring that the context and relationships within the data are preserved by the system 150. Such knowledge bases may be stored in the vector database 156, which for purposes of explanation is shown in FIG. 1B as being a single vector database 156 but in some examples may comprise a plurality of vector databases 156. The system 150 may use knowledge bases stored in the vector database(s) 156 (and/or elsewhere) to generate responses as described herein. When a user's 153 question 162 is received, the system 150 may convert the question 162 into an embedding, retrieve relevant data from the vector database 156 using vector search, and/or generate responses using the assistant application 158. The retrieved data forms a context 166 that is then used to provide a contextually accurate and relevant answer(s) 168. Additionally, the context 166 may comprise contextual metadata.

As shown in FIG. 1B, the system 150 may further comprise an associative engine 170. The associative engine 170 may correspond to the AE module 102B of the computing device 102 (e.g., the client device(s) associated with the user(s) 153). When a user 153 sends a question 162, (e.g., seeks an insight(s) by asking a natural language question and/or by interacting with a visual analytic interface by selecting a chart or a portion of a chart for explanation), the associative engine 170 gathers contextual metadata about the user's 153 current analytical context. This contextual metadata can include, but is not limited to: data hypercubes or subsets relevant to the question 162 (e.g., dimensions, measures, and/or their values), a current selection state (e.g., filters applied, like specific regions, products, or time periods selected), a data model schema and/or relationships (e.g. how fields and tables are connected), the user's 153 selection or query history (e.g., what the user 153 looked at or asked just before, to maintain context in a conversational thread), and/or any annotations or rules defined in a corresponding analytics-system app (e.g., labels like “High-value customer” or custom calculations defined by the user 153).

The associative engine 170 integrates with the vector database 156 and the assistant application 158 to provide interactive analytical capabilities. The associative engine 170 may maintain dynamic relationships between data elements and enable real-time exploration of data associations. The system 150 may provide session-specific analytics capabilities through the associative engine 170. The associative engine 170 may operate in a dedicated in-memory environment. The dedicated in-memory environment may be isolated to individual user sessions. In some cases, the associative engine 170 may run within a user's browser as a client-side process. In other cases, the associative engine 170 may execute in a dedicated in-memory process on a server. The dedicated server process may be isolated to a specific user session.

The in-memory processing capabilities may enable real-time computation without requiring queries to remote servers. The associative engine 170 may perform all data filtering, aggregation, and recalculation operations using data already loaded into memory. In some cases, user interactions such as selections and filters may trigger instantaneous updates to visualizations. The associative engine 170 may avoid latency associated with database queries or network communication during interactive exploration. The in-memory architecture may support high-performance analytical operations. The associative engine 170 may handle large datasets by maintaining indexed data structures in memory. In some cases, the associative engine 170 may process millions of records with sub-second response times for filtering and aggregation operations. The memory-resident approach may eliminate input/output bottlenecks associated with disk-based data access during interactive analysis.

The dynamic dashboard generation process may transform static AutoML results into interactive analytical interfaces. The system 150 may utilize pre-defined visualization templates tailored for machine learning experiment analysis. These templates may be instantiated dynamically when an AutoML experiment completes and may be bound to data stored within the associative engine 170. The template system may include a library of visualization definitions designed for typical model outputs. The library may contain templates for confusion matrices, feature importance bar charts, SHAP value plots, partial dependence charts, what-if scenario interfaces, and model comparison visualizations. Each template may define the structure, layout, and interactive behaviors for a specific type of analytical visualization.

When an experiment concludes, the system 150 may select appropriate templates based on the model type and available metadata. For classification models, the system 150 may instantiate confusion matrix templates and classification-specific performance metric displays. For regression models, the system 150 may generate scatter plot templates and regression-specific error metric visualizations. The template selection process may be automated based on the characteristics of the trained model and the type of prediction task.

A binding process may connect template definitions to specific data tables within the associative engine 170. A feature importance template may be bound to a table containing SHAP values and feature metadata. A prediction distribution template may be connected to a table containing model predictions and actual outcomes. The binding process may establish relationships between template elements and data fields, enabling dynamic population of visualizations with experiment-specific results.

The associative engine 170 may be implemented for embedding charts within web-based interfaces. These implementation approaches may enable the creation of interactive visualizations that respond to user selections and filters. One or more APIs may provide programmatic access to associative engine functionality, allowing custom applications to embed analytics. The template instantiation process may create session-specific analytical applications. Each instantiated template may become a live visualization connected to the in-memory data context. The visualizations may update automatically when users make selections or apply filters through the associative interface. Multiple templates may be combined to create comprehensive analytical dashboards containing various perspectives on the model results.

The system 150 may support customization of instantiated templates based on user preferences or organizational standards. Template parameters may be adjusted to modify color schemes, chart types, or layout arrangements. Custom templates may be created and added to the template library for specialized analytical requirements. The template system may maintain separation between visualization logic and data binding, enabling reuse of templates across different experiments and datasets. Dynamic dashboard generation may occur within the user's session without requiring server-side processing for each interaction. The associative engine 170 may handle all computational requirements for updating visualizations in response to user actions. This approach may eliminate latency associated with server round-trips and may enable real-time exploration of model results through interactive dashboard interfaces.

The analytics capabilities may be embedded directly within the AutoML user interface to provide seamless workflow integration. In some cases, users may transition from model training to interactive analysis without switching contexts or tools. The system 150 may provide multiple options for presenting the analytical results to users. The dashboard may be embedded directly into the AutoML user interface. In some cases, the embedded dashboard appears as an integrated panel within the same interface where users configure and execute AutoML experiments. The embedded approach may allow users to view model results immediately after training completion without navigating to a separate application or opening additional browser tabs. The AutoML interface may include designated areas or sections where the analytical visualizations appear once model training concludes.

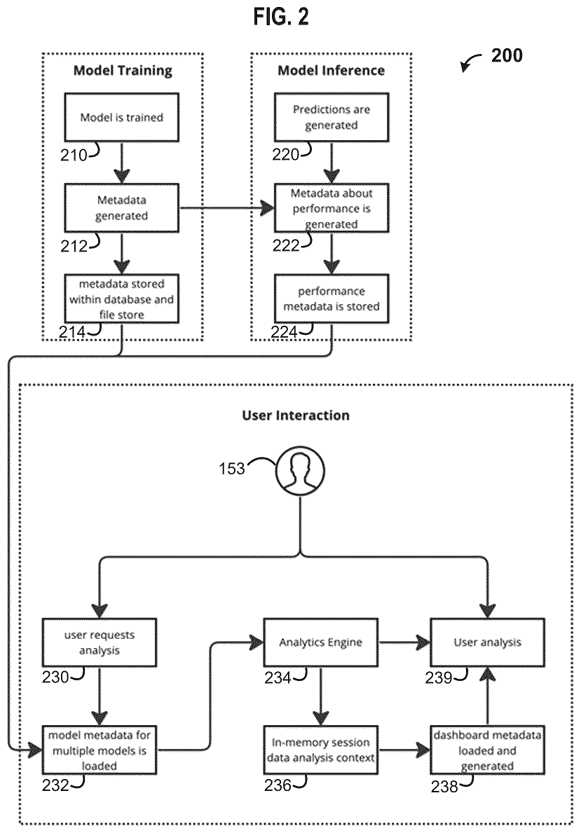

FIG. 2 depicts a workflow 200 that demonstrates how the system 150 executes integrated machine learning and analytical processes. The workflow 200 comprises three distinct phases that coordinate to deliver contextual metadata and interactive analysis capabilities. The workflow 200 may be executed by various components of the system 150 working in coordination. The workflow 200 begins with model training operations that generate machine learning models and associated metadata. At training step 210, the system 150 initiates model training using automated machine learning processes. For example, the user 153 may interact with the assistant application 158 via a client device, such as client device 102 outputting one or more dashboards as described herein. The training step 210 may involve data preprocessing, feature engineering, and algorithm selection operations, which may be performed and/or directed by the assistant application 158 (e.g., performed locally at the client device and/or remotely, such as at any of the servers 106B, 108B, 110B). At training step 212, the system may generate metadata during the model training process. For example, the system 150, via the assistant application 158 and/or any of the servers 106B, 108B, 110B, may generate this metadata. The training step 212 may capture information about model parameters, feature selections, training configurations, and performance metrics as described herein. At training step 214, the system 150, via the assistant application 158 and/or any of the servers 106B, 108B, 110B, may store the generated metadata within database and file storage systems, such as within any of the databases 106A, 108A, 110A. The database and file storage systems may utilize persistent storage mechanisms to preserve training information for subsequent retrieval.

The workflow 200 continues with model inference operations that apply trained models to generate predictions and performance data. At inference step 220, the system 150, via the assistant application 158 and/or any of the servers 106B, 108B, 110B, may generate predictions using the trained models on validation and/or test datasets. At the inference step 220, the system 150, via the assistant application 158 and/or any of the servers 106B, 108B, 110B, may produce classification results, regression outputs, and/or probability scores (e.g., depending on the model type). The system 150, via the assistant application 158 and/or any of the servers 106B, 108B, 110B, may store the classification results, regression outputs, and/or probability scores within the database and file storage systems.

At inference step 222, the system 150, via the assistant application 158 and/or any of the servers 106B, 108B, 110B, may generate metadata about model performance during the inference process (“performance metadata”). Performance of the inference step 222 may involve computation of accuracy metrics, confusion matrix values, and/or explanation data, such as SHAP values. The system 150, via the assistant application 158 and/or any of the servers 106B, 108B, 110B, may store the accuracy metrics, confusion matrix values, and/or explanation data within the database and file storage systems. At inference step 224, the system 150, via the assistant application 158 and/or any of the servers 106B, 108B, 110B, may store the performance metadata within the database and file storage systems (e.g., the same database and file storage systems used by the training step 214). The inference step 224 may maintain consistency between training and inference metadata storage.

The system 150 provides contextual metadata capabilities by capturing comprehensive information during model training and inference operations. As an example, when a user 153 is configuring an AutoML experiment/session, which may correspond to one or more steps of the workflow 200, the associative engine 170 may gather contextual metadata about the user's 153 current analytical context. The current analytical context may comprise (or be based on) one or more selection states of data, a dashboard(s), a component of a dashboard(s), etc.

The contextual metadata may include feature importance rankings, model parameter settings, data preprocessing steps, explanation values for individual predictions, a combination thereof, and/or the like. Additionally, or in the alternative, the contextual metadata can include data hypercubes or subsets (e.g., dimensions, measures, and/or their values), one or more current selection states (e.g., filters applied, like specific regions, products, or time periods selected), a schema and/or relationships for a data model(s) (e.g. how fields and tables are connected), the user's 153 selection or query history (e.g., what the user 153 looked at or asked just before, to maintain context in a conversational thread), any annotations or rules defined in a corresponding analytics-system app (e.g., labels like “High-value customer” or custom calculations defined by the user 153), a combination thereof, and/or the like.

A current selection state may include information about any filters or selections that the user 153 has applied to the data. The current selection state may include specific regions, products, time periods, or other dimensional values that are currently selected or excluded. The associative engine 170 may provide comprehensive information about both selected and excluded values. The associative engine 170 may enable the system 150 to consider the full context of the user's 153 analytical focus. Hypercube data may represent the specific data subsets that are relevant to a current selection state(s). The associative engine 170 may quickly generate these data cubes by applying the current selections and filters to the underlying data model. The hypercube data may include aggregated values, dimensional breakdowns, and statistical measures that are pertinent to the analysis. The associative engine's 170 in-memory architecture may enable sub-second response times for retrieving this contextual metadata.

Data model relationships may provide information about how different tables and fields in the data model are connected. This information may be crucial for understanding the context of the data and takes into account the full complexity of the data model. In addition to these elements, the contextual metadata may also include information about excluded data values. These excluded data values may be data values that are not associated with the current user 153 selections but may still be relevant for providing comprehensive analytical context. For example, if a user 153 has selected to view data for a specific region, the system 150 may also consider data from other regions to provide a more complete picture or to highlight any significant differences. When the system 150 performs the workflow 200, the associative engine 170 may index the contextual metadata to enable rapid exploration and filtering based on any captured attribute.

Returning to FIG. 2, the workflow 200 then moves to analysis steps 230-238 where user interactions and the associative engine 170 enable interactive exploration of model results. At analysis step 230, the system 150, via the assistant application 158 and/or any of the servers 106B, 108B, 110B, may receive a request(s) from the user 153 for model analysis. The analysis step 230 may trigger the loading of stored metadata into analytical processing systems (e.g., into the assistant application 158, the client device 102, the associative engine 170, etc.). At analysis step 232, the system 150, via the assistant application 158 and/or any of the servers 106B, 108B, 110B, loads model metadata (e.g., contextual metadata, model performance metadata, etc.) for multiple models from within the database and file storage systems mention above into memory. For example, the model metadata for the multiple models may be loaded into the primary memory/RAM of the client device (e.g., client device 102) on which the assistant application 158 and/or the associative engine 170 is executing. As part of performing the analysis step 232, the system 150, via the assistant application 158 and/or any of the servers 106B, 108B, 110B, may retrieve both training and inference metadata to provide comprehensive analytical context.

The system 150 provides interactive analysis capabilities through the associative engine 170 that maintains dynamic relationships between all loaded data elements. The interactive analysis capabilities may allow the user 153 to make selections on any data dimension and observe immediate updates across all related visualizations and metrics. The associative engine 170 may recalculate aggregations and filter results in real-time without requiring additional queries to external data sources.

Returning to FIG. 2, the workflow 200 then moves to analysis step 234 where the associative engine 170 processes the model metadata (e.g., contextual metadata, model performance metadata, etc.) loaded at step 232. As part of analysis step 234, the associative engine 170 may create in-memory data structures that enable rapid querying and filtering operations. At analysis step 236, the associative engine 170 establishes an in-memory session data analysis context that provides the computational environment for interactive exploration. As part of the analysis step 236, the associative engine 170 may maintain user-specific data states and selection contexts, for example. At step 238, the associative engine 170 loads and generates dashboard metadata to create visualization templates. As part of step 238, the associative engine 170 may instantiate pre-defined chart configurations and bind the chart configurations to the loaded model data, for example. At analysis step 239, the associative engine 170 enables user analysis through interactive dashboard interfaces. As part of the analysis step 239, the associative engine 170 may provide real-time responsiveness to user selections and filtering operations.

The data transfer between AutoML service components of the system 150 and the associative engine 170 can be implemented through APIs, intermediate data stores, or high-speed messaging interfaces. These transfer mechanisms may enable efficient movement of training metadata, inference results, and performance data from model generation processes to the associative engine 170. The transfer mechanisms may support various data formats and volumes while maintaining data integrity and processing efficiency.

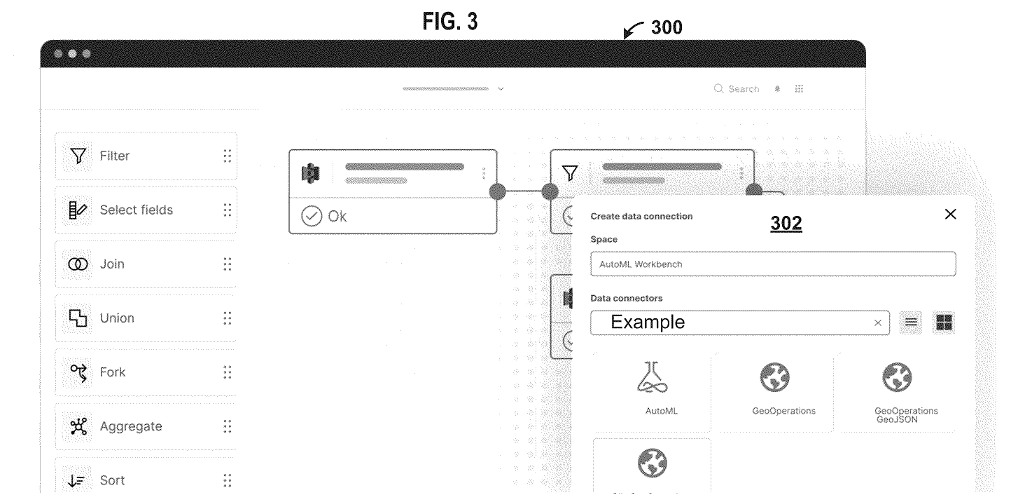

FIG. 3 illustrates a dashboard 300 for configuring an AutoML experiment, such as the one referenced above regarding FIG. 2 and the workflow 200. The dashboard 300 may provide a user interface for setting up data connections and preparing datasets for machine learning experiments. The dashboard 300 may include a configuration panel 302 positioned on the left side of the interface. The configuration panel 302 may contain various controls and options for setting up the machine learning experiment. The machine learning experiment may involve various types of predictive modeling tasks including classification, regression, or time series forecasting. For example, the experiment may focus on customer churn prediction where the system analyzes customer behavior patterns to predict likelihood of service cancellation.

The configuration panel 302 may include data connection settings and parameter selections. In some cases, the configuration panel 302 may allow users to specify data sources and configure connection parameters for accessing datasets. The configuration panel 302 may provide options for selecting different types of data connections and configuring authentication settings. For example, for customer churn analysis scenarios, the data sources may include customer transaction records, service usage logs, billing information, and customer support interactions. The system may accommodate various other analytical domains beyond customer churn prediction.

The dashboard 300 may display a workflow diagram in the main area. The workflow diagram may show connected nodes representing different stages of the data processing and model training pipeline. In some cases, the workflow diagram may provide a visual representation of the data flow from source to model training. The workflow may include data ingestion, preprocessing, feature engineering, model training, and evaluation stages. Each stage may be configured through the dashboard 300 interface to accommodate specific requirements of the analytical task. The dashboard 300 may include navigation elements and status indicators throughout the interface. The navigation elements may allow users to move between different sections of the AutoML configuration process. The status indicators may provide feedback on the current state of data connections and configuration settings. The interface may display progress indicators during data loading and validation operations.

The data store may include QVD files for storing processed data. In some cases, the data store may include object stores for managing large datasets and model artifacts. The data store may also include JSON or CSV formats for storing AutoML results. The JSON format may be used for storing structured metadata about model training and performance metrics. The CSV format may be used for storing tabular data such as prediction results and feature importance scores. Returning to the churn example, the stored data may include customer demographic information, behavioral metrics, and churn indicators when the system is applied to customer retention analysis. The configuration panel 302 may provide options for specifying the format and location of stored AutoML results. In some cases, users may select between different storage formats based on their downstream analysis requirements. The configuration panel 302 may allow users to configure how model metadata and results are persisted after training completion. The configuration may include settings for data retention, access permissions, and integration with external systems.

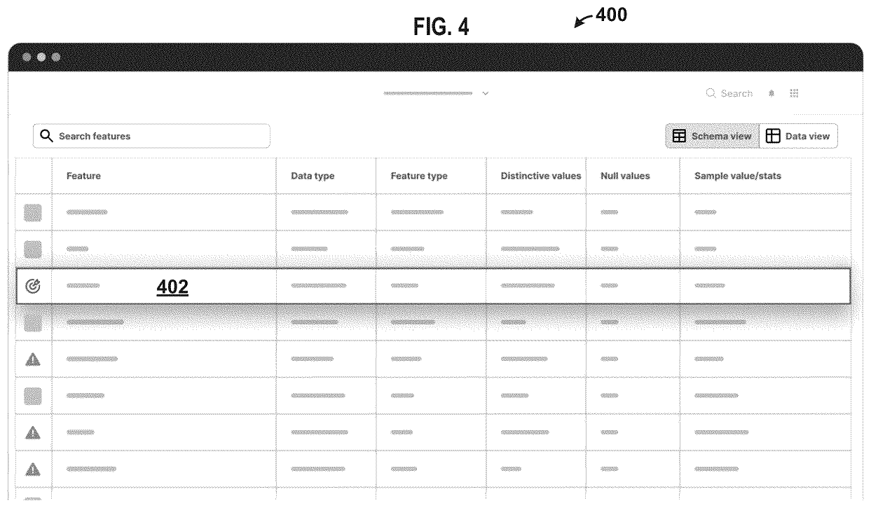

FIG. 4 illustrates a dashboard 400 for target selection and feature configuration in automated machine learning experiments. The dashboard 400 may provide an interface for users to review dataset characteristics and configure machine learning parameters. The interface may support various types of predictive modeling objectives including binary classification, multi-class classification, and regression tasks. For example, in customer churn prediction scenarios, the target variable may represent whether a customer discontinued service within a specified time period. The dashboard 400 may display a tabular representation of dataset features. Each row in the table may correspond to a different feature or field from the dataset. The columns may show various properties associated with each feature. These properties may include feature names, data types, feature types, distinct value counts, null counts, and sample statistics. For customer churn analysis, the features may include customer tenure, monthly charges, contract type, payment method, and service usage patterns. The system may accommodate features from various other analytical domains.

The dashboard 400 may include a selected target 402. The selected target 402 may be highlighted with visual indicators to distinguish the target variable from other features. The selected target 402 may represent the outcome variable that the machine learning model will attempt to predict based on other available features in the dataset. For example, in customer churn scenarios, the selected target 402 may indicate a binary churn status or a churn probability score, etc. The dashboard 400 may display warning indicators for certain features. These warning indicators may appear as orange triangular icons positioned next to specific features. The warning indicators may signal potential data quality issues. In some cases, these issues may include high cardinality, excessive missing values, or other characteristics that may require attention during the modeling process. For customer data, warnings may appear for features with inconsistent formatting, outlier values, or incomplete records.

The interface may allow users to examine feature metadata before initiating model training. Users may review the distinct value counts to understand feature cardinality. Users may also examine null counts to assess data completeness. The sample statistics may provide additional insights into feature distributions and ranges. The metadata examination may help users identify potential issues with customer identifiers, categorical variables, or numerical measurements. The dashboard 400 may enable users to modify feature selections. Users may include or exclude specific features from the modeling process. The interface may provide controls for adjusting feature types or preprocessing options. In some cases, users may change data type classifications or apply transformations to address data quality issues identified through the warning indicators. Feature modifications may include encoding categorical variables, scaling numerical features, or creating derived variables.

The target selection process may involve identifying the prediction objective for the machine learning experiment. The selected target 402 may define what outcome the model will predict. In some cases, the selected target 402 may be a binary classification variable, a multi-class categorical variable, or a continuous regression target. For customer churn analysis, the target may represent churn status, churn probability, or time until churn occurrence. The dashboard 400 may facilitate data preparation workflows. Users may address data quality issues before proceeding with model training. The interface may provide options for handling missing values, encoding categorical variables, or applying feature scaling. These preprocessing steps may be configured through the dashboard 400 interface. The preprocessing may include customer data standardization, outlier detection, and feature transformation operations.

The feature configuration interface may support various data types. Numerical features may be displayed with statistical summaries including minimum, maximum, and mean values. Categorical features may show distinct value counts and frequency distributions. Text features may display character length statistics or other relevant metadata. In the churn example, customer data may include numerical features such as account balance and tenure, categorical features such as service plan type, and text features such as customer feedback comments.

The dashboard 400 may provide validation feedback during target selection. The interface may verify that the selected target 402 contains appropriate values for the intended modeling task. In some cases, the dashboard 400 may display warnings if the target variable has insufficient variation or other characteristics that may impact model performance. For churn prediction, as an example, the system may validate that the target variable contains balanced representation of churned and retained customers.

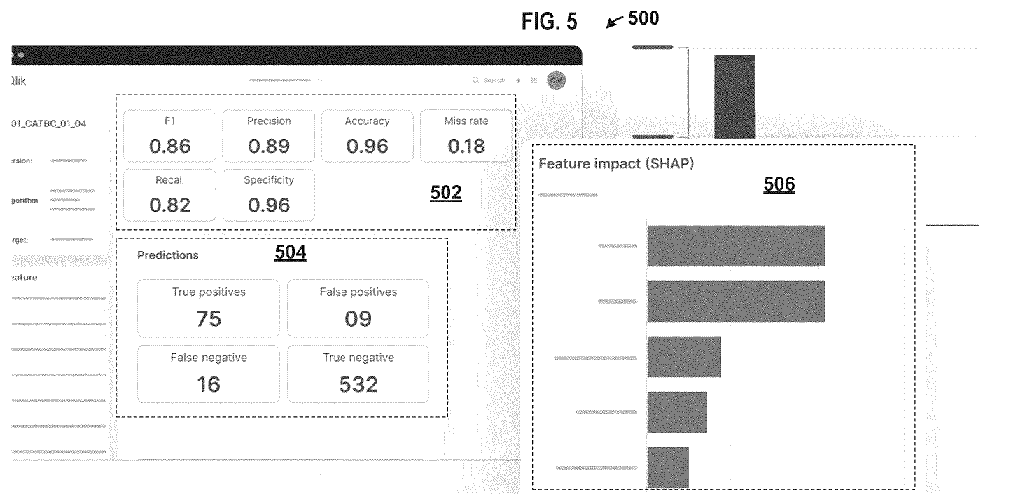

FIG. 5 illustrates a dashboard 500 displaying model performance visualization and metrics for an automated machine learning experiment. The dashboard 500 may present comprehensive performance indicators and explanatory information for model results generated by the machine learning module 102A. The performance visualization may apply to various types of predictive modeling tasks including classification, regression, and time series forecasting. In customer churn prediction applications, as an example, the dashboard 500 may display metrics specific to binary classification performance.

The dashboard 500 may include metrics 502. The metrics 502 may display numerical performance indicators such as accuracy measures, precision values, recall statistics, and F1 scores. The metrics 502 may provide immediate visual feedback regarding the performance characteristics of the selected machine learning model. For customer churn models, as an example, these metrics may indicate the model's ability to correctly identify customers likely to discontinue service. The dashboard 500 may further include predictions 504 displayed as a confusion matrix visualization. The predictions 504 may present classification results in a structured format showing actual versus predicted outcomes. The predictions 504 may enable users to understand the distribution of correct and incorrect classifications made by the model. For example, in customer churn scenarios, the confusion matrix may show how accurately the model identifies customers who will churn versus those who will remain.

The dashboard 500 may also incorporate a graph 506 showing feature importance information. The graph 506 may display SHAP (SHapley Additive explanations) values for model explainability. The associative engine 102B/170 may use SHAP values to provide detailed explanations of how individual features contribute to model predictions. The graph 506 may enable interactive exploration of feature contributions through the associative engine 102B. For customer churn models, as an example, the SHAP values may reveal which customer characteristics most strongly influence churn predictions.

The machine learning module 102A may use multiple algorithms, such as CatBoost classifier, for generating the model results displayed in the dashboard 500. The machine learning module 102A may perform automatic algorithm selection and hyperparameter tuning to determine the optimal model configuration. In some cases, the selected algorithm may be indicated within the dashboard 500 interface. The algorithm selection may consider the specific characteristics of the dataset and prediction task. The dashboard 500 may enable real-time interaction with the displayed performance information through the associative engine 102B/170. Users may make selections on any portion of the metrics 502, predictions 504, or graph 506 to filter and explore specific aspects of model performance. The associative engine 102B/170 may instantly recalculate and update all visualizations based on user selections, providing contextual analysis of model behavior for different data subsets. Users may explore performance variations across different customer segments or time periods.

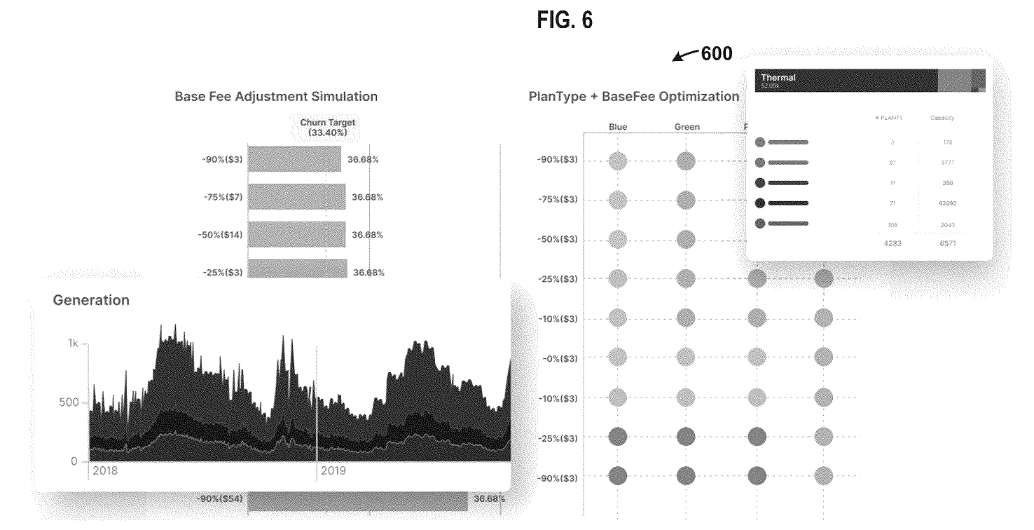

The system may provide what-if scenario analysis capabilities through interactive visualization interfaces. FIG. 6 illustrates an example dashboard 600 displaying comprehensive scenario analysis tools for exploring parameter combinations and their impact on model predictions. The scenario analysis may apply to various types of business optimization problems including pricing strategies, resource allocation, and operational planning. In customer churn prevention scenarios, as an example, the dashboard 600 may enable exploration of retention strategies and their predicted effectiveness.

Using the churn example, the dashboard 600 may include base fee adjustment simulation capabilities, such as a bar chart showing percentage values corresponding to different fee modification scenarios. Each bar in the simulation may represent a different discount level, such as −90%, −75%, −50%, −25%, and other percentage adjustments. The bars may display corresponding predicted outcomes, such as churn rates or other target metrics, allowing users to visualize how fee adjustments may affect model predictions. For customer retention analysis, the simulation may show how pricing changes influence customer churn probability across different discount levels. The fashboard 600 may also include a plan type optimization matrix. The optimization matrix may display a grid of colored indicators representing different combinations of plan types and fee adjustments. Each cell in the matrix may correspond to a specific combination of plan type and fee modification level. The color coding may indicate the predicted impact on the target outcome, with different colors representing varying levels of risk or performance metrics. In customer churn applications, the matrix may show how different service plans combined with pricing adjustments affect customer retention rates.

The dashboard 600 may support real-time what-if analysis with interactive sliders and dropdowns for parameter adjustment (not shown). Users may manipulate input parameters through these interactive controls to explore different scenarios. The sliders may allow continuous adjustment of numerical parameters, while dropdowns may provide selection options for categorical variables. Changes made through these controls may trigger immediate updates to the visualization components. Using the churn example, the parameter adjustments may include pricing modifications, service level changes, or promotional offer configurations.

The associative engine 170 may enable dynamic recalculation of scenario outcomes based on user parameter adjustments. When users modify parameters through the interactive controls, the associative engine 170 may process the changes and update all related visualizations in real-time. The associative engine 170 may maintain relationships between different parameters and outcomes, allowing for comprehensive scenario exploration.

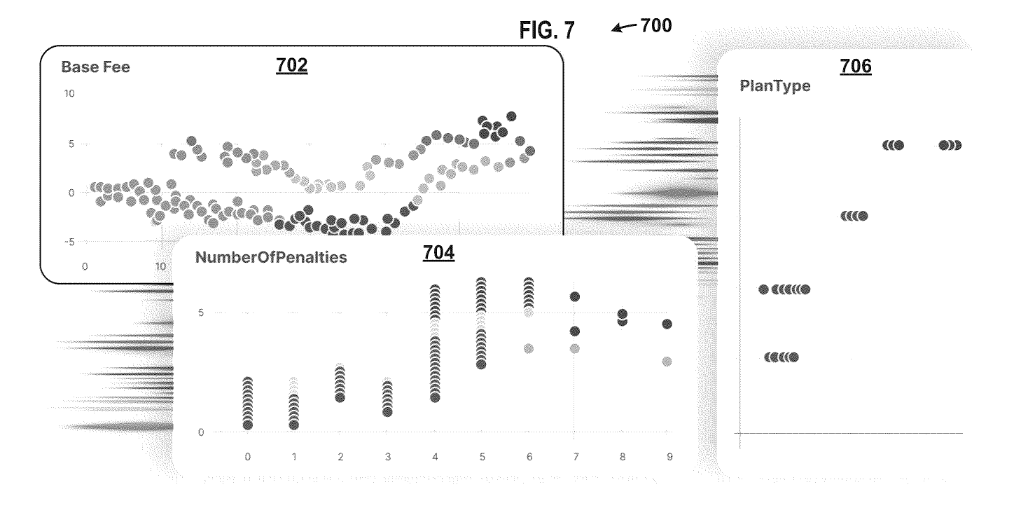

The system may provide interactive feature analysis capabilities through associative visualizations. FIG. 7 illustrates a dashboard 700 displaying scatter plot visualizations for exploring relationships between features and model predictions. The dashboard 700 may include multiple analytical views for examining feature impacts on prediction outcomes. The feature analysis may apply to various types of predictive modeling tasks across different business domains. In customer churn analysis, as an example, the scatter plots may reveal how customer characteristics influence churn probability predictions. For example, the dashboard 700 may contain a graph 702 showing the relationship between base fee values and prediction influences. In some cases, the data points in the graph 702 may be color-coded to represent different categories or segments within the dataset. In the churn example, the graph 702 may enable users to identify patterns in how base fee variations affect model predictions across different customer segments, such as how monthly charges may correlate with churn probability across different customer types.

The dashboard 700 may also include a graph 704 for analyzing a particular variable(s) (e.g., penalty-related effects on predictions). For example, in customer churn scenarios, penalties may represent service interruptions, late payments, or customer complaints. Additionally, the dashboard 700 may present a graph 706 for examining influences of another variable(s) (e.g., plan type) on model predictions. The graph 706 may allow users to compare how different variable(s) values (e.g., plan types) contribute to prediction outcomes. The associative engine may enable interactive exploration across all graphs within the dashboard 700. In some cases, selecting data points or ranges in one graph may automatically filter and update the other graphs to show corresponding subsets of data. The system may support lasso selection, point selection, or range filtering within any of the scatter plots. When users make selections in the graph 702, the graph 704 and graph 706 may update to reflect only the data points corresponding to the selected subset. The interactive filtering may enable analysis of specific customer segments or feature combinations.

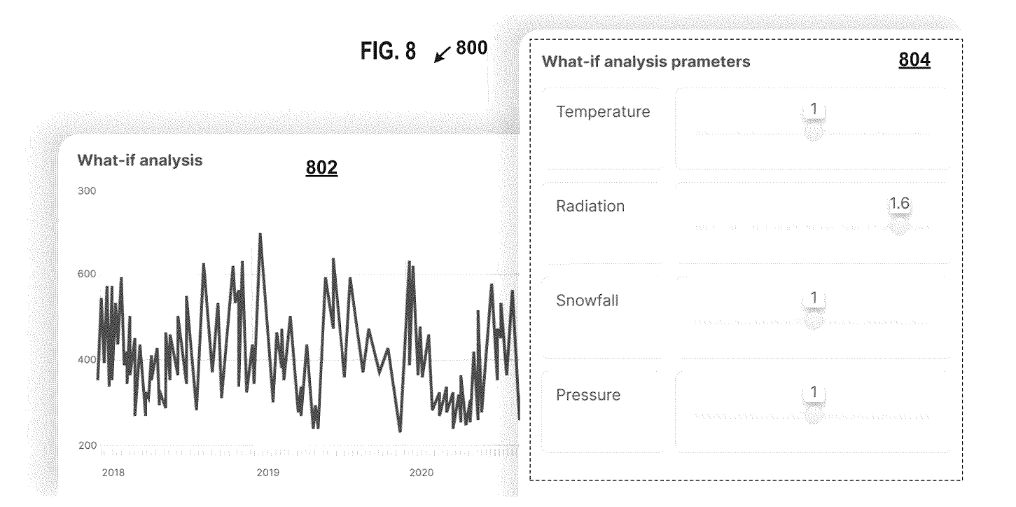

FIG. 8 illustrates a dashboard 800 for interactive what-if analysis with parameter controls. The dashboard 800 may provide real-time parameter adjustment capabilities through an integrated interface. The dashboard 800 may display a graph 802 showing a time series visualization with fluctuating data points plotted over time. The graph 802 may track variations in a measured outcome or prediction across a temporal sequence. The time series analysis may apply to various types of forecasting tasks including demand prediction, performance monitoring, and trend analysis. In customer churn applications, as an example, the graph 802 may show predicted churn rates over time under different scenario conditions.

Adjacent to the graph 802, the dashboard 800 may include a section 804 for adjusting one or more parameters via adjustable input controls. The parameters section 804 may present several slider controls or input fields. The slider controls may allow users to modify different variables in real-time. Each parameter control in the parameters section 804 may correspond to a specific input variable. The input variables may influence model predictions or scenario outcomes. For customer churn scenarios, as an example, the parameters may include pricing adjustments, service quality metrics, promotional offer intensities, or competitive pressure indicators.

The dashboard 800 may enable real-time interaction where adjustments made through the parameters 804 section can dynamically update the visualization shown in the graph 802. In some cases, the system may provide immediate feedback through the time series visualizations when users adjust parameters for what-if analysis. The real-time updates may occur without requiring separate analysis tools or manual recalculation processes. The immediate feedback may enable rapid evaluation of different business strategies and their predicted temporal effects.

In some cases, the associative engine 170 may process parameter adjustments and recalculate predictions in memory. The in-memory processing may eliminate the need for database queries or server calls during parameter modifications. The dashboard 800 may provide an integrated interface for exploring different parameter combinations. Users may observe corresponding changes in predicted outcomes displayed in the graph 802 through the real-time visualization updates. The high-performance processing may support complex scenario analysis with large datasets. The parameter adjustment interface may include various types of controls for modifying input variables. In some cases, the controls may include sliders for continuous variables, dropdown menus for categorical selections, or input fields for specific numerical values. The parameters section 804 may allow simultaneous adjustment of multiple variables. The graph 802 may update instantaneously to reflect the combined effects of multiple parameter changes. The multi-parameter adjustment may support complex business scenario modeling with interdependent variables.

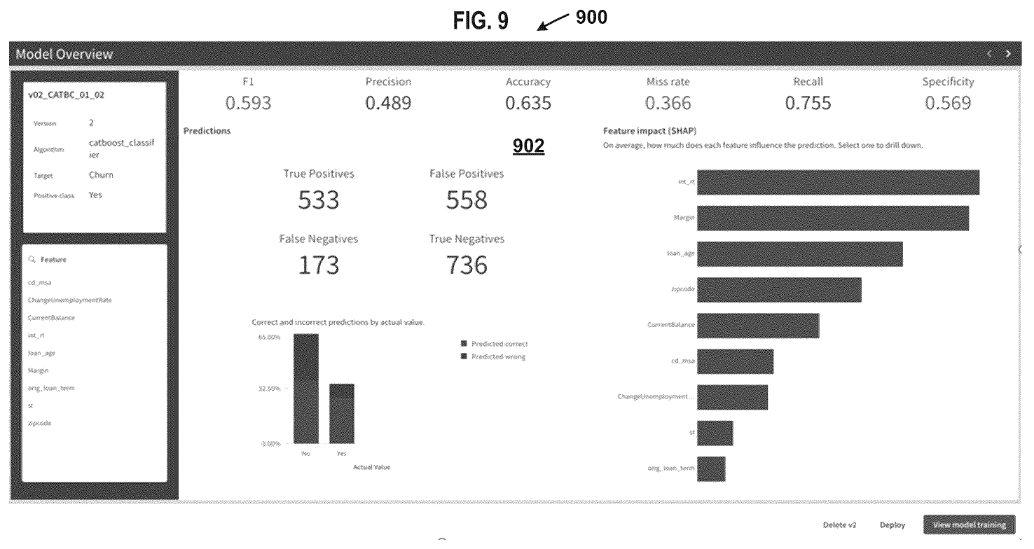

FIG. 9 illustrates a dashboard 900 displaying model performance metrics and analysis results. The dashboard 900 includes a model overview 902 section that presents various performance indicators and statistical measures in a structured layout with numerical values and graphical elements for analyzing machine learning model results. The model overview 902 may support various types of analytical tasks including classification, regression, clustering, and anomaly detection. In customer churn prediction applications, as an example, the model overview 902 may present metrics specific to binary classification performance and customer retention analysis. The dashboard 900 may provide a comprehensive interface for examining machine learning experiment outcomes. In some cases, the dashboard 900 may integrate multiple visualization components to present a complete view of model performance and analytical results. The model overview 902 may display performance metrics in an organized format that allows users to assess model quality and effectiveness. The comprehensive view may enable users to evaluate model suitability for deployment in production environments.

The dashboard 900 may include templated visualizations such as confusion matrices, feature importance bar charts, SHAP value plots, partial dependence charts, model comparison charts, and what-if scenario charts. In some cases, these templated visualizations may be dynamically generated based on the specific machine learning experiment results. The confusion matrices may display classification accuracy by showing true positives, false positives, true negatives, and false negatives in a structured grid format. For example, for customer churn models, the confusion matrix may show the accuracy of churn predictions across different customer segments.

Feature importance bar charts may present the relative significance of different input variables in the model's decision-making process. In some cases, SHAP value plots may provide explanations for individual predictions by showing how each feature contributes to specific outcomes. The SHAP value plots may enable users to understand the reasoning behind particular model predictions. For example, for customer churn analysis, the feature importance may reveal which customer characteristics most strongly influence churn predictions, such as contract length, payment history, or service usage patterns.

The model overview 902 may present statistical measures including accuracy, precision, recall, F1-score, and other relevant performance indicators. In some cases, the model overview 902 may organize these metrics in a layout that facilitates quick assessment of model quality. The numerical values displayed in the model overview 902 may correspond to the performance of the selected machine learning model on validation or test datasets. The performance metrics may be tailored to the specific analytical task and business objectives.

The dashboard 900 may provide an integrated environment where users can examine different aspects of model performance without switching between separate interfaces. In some cases, the dashboard 900 may enable users to drill down into specific performance areas or explore detailed explanations for model behavior. The graphical elements within the model overview 902 may include charts, meters, or other visual indicators that represent model performance in an easily interpretable format. The integrated environment may support comprehensive model evaluation and business impact assessment.

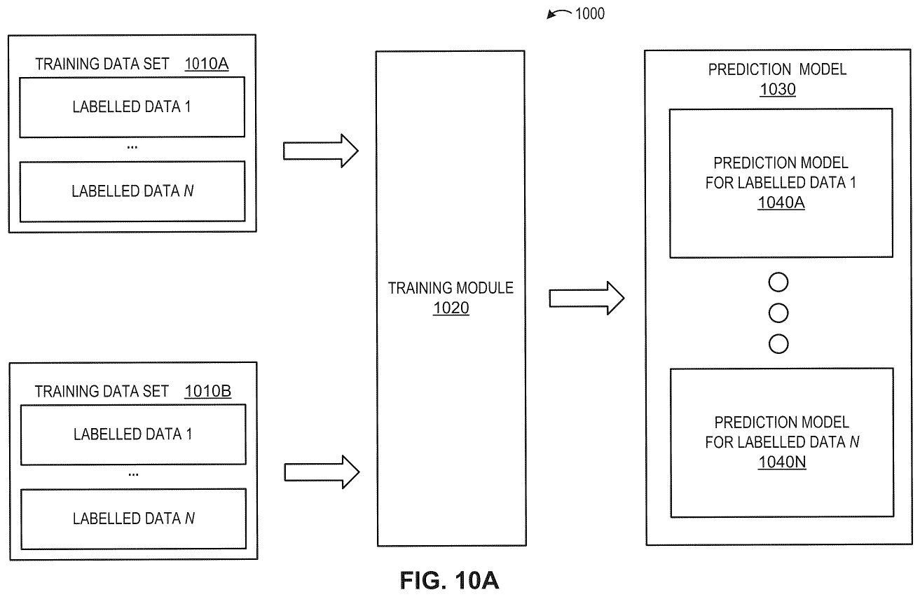

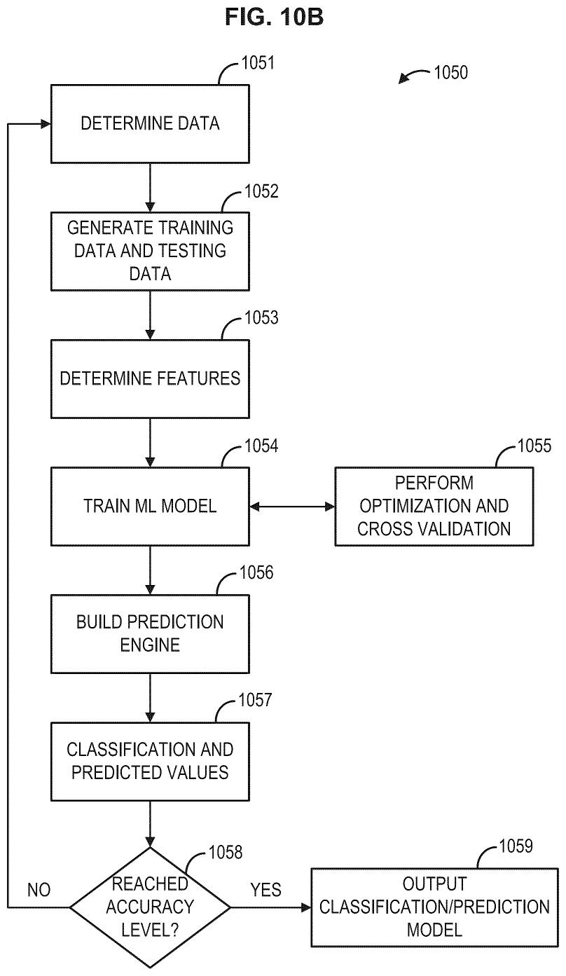

FIG. 10A shows an example training system 1000 for machine-learning model training. The training system 1000 may be configured to use machine-learning techniques to train, based on an analysis of a plurality of training datasets 1010A-1010B by a training module 1020, a prediction model 1030. Some functions of the training system 1000 described herein may be performed, for example, by one or more devices/components of the system 100 and/or the system 150, or another computing device in communication therewith. The plurality of training datasets 1010A-1010B may be associated with input data or annotated data described herein. For example, the first training dataset 1010A may comprise one or more labeled data (e.g., labeled data 1-N). Each of the one more labeled data in the first training dataset 1010A may comprise one or more inputs (e.g., input features) and corresponding known outputs associated with the one or more inputs. For the churn example, labeled data 1 of the first training dataset 1010A may comprise customer demographic information, service usage patterns, billing history, contract details, payment methods, and historical churn indicators for automated machine learning experiments.

The training datasets 1010A, 1010B may be based on, or comprise, data stored in one or more devices/components of the system 100 and/or the system 150, or another computing device in communication therewith. Such data may be randomly assigned to the first training dataset 1010A, the second training dataset 1010B, and/or to a testing dataset. In some implementations, assignment may not be completely random and one or more criteria or methods may be used during the assignment. For example, the first training dataset 1010A and/or the second training dataset 1010B may be generated based on temporal splits to ensure model validation reflects real-world deployment scenarios where predictions are made on future data. In general, any suitable method may be used to assign the data to the training and/or testing datasets.

The training module 1020 may train the prediction model 1030 by determining/extracting the features from the first training dataset 1010A and/or the second training dataset 1010B in a variety of ways. For example, the training module 1020 may determine/extract a feature set from the first training dataset 1010A and/or the second training dataset 1010B. The training module 1020 may determine/extract a feature set from the first training dataset 1010A and/or the second training dataset 1010B to enable automated feature engineering and preprocessing for machine learning model development. The training module 1020 may use the feature sets to generate prediction models 1040A-1040N.

The first training dataset 1010A and/or the second training dataset 1010B may be analyzed to determine any dependencies, associations, and/or correlations between features in the first training dataset 1010A and/or the second training dataset 1010B. The identified correlations may have the form of a list of features that are associated with different labeled predictions. The term “feature,” as used herein, may refer to any characteristic of an item of data that may be used to determine whether the item of data falls within one or more specific categories or within a range. A feature selection technique may comprise one or more feature selection rules. The one or more feature selection rules may comprise a feature occurrence rule. The feature occurrence rule may comprise determining which features in the first training dataset 1010A occur over a threshold number of times and identifying those features that satisfy the threshold as candidate features. For example, any features that appear greater than or equal to 10 times in the first training dataset 1010A may be considered as candidate features. Any features appearing less than 10 times may be excluded from consideration as a feature. Other threshold numbers may be used as well.

A single feature selection rule may be applied to select features or multiple feature selection rules may be applied to select features. The feature selection rules may be applied in a cascading fashion, with the feature selection rules being applied in a specific order and applied to the results of the previous rule. For example, the feature occurrence rule may be applied to the first training dataset 1010A to generate a first list of features. A final list of candidate features may be analyzed according to additional feature selection techniques to determine one or more candidate feature groups (e.g., groups of features that may be used to determine a prediction). Any suitable computational technique may be used to identify the candidate feature groups using any feature selection technique such as filter, wrapper, and/or embedded methods. One or more candidate feature groups may be selected according to classifiers and/or a statistical method. The classifiers and/or statistical method may include, for example, Pearson's correlation, linear discriminant analysis, analysis of variance (ANOVA), chi-square, combinations thereof, and the like. The selection of features according to filter methods are independent of any machine-learning algorithms used by the training system 1000. Instead, features may be selected on the basis of scores in various statistical tests for their correlation with the outcome variable (e.g., a prediction).

As another example, one or more candidate feature groups may be selected according to a wrapper method. A wrapper method may be configured to use a subset of features and train the prediction model 1030 using the subset of features. Based on the inferences that may be drawn from a previous model, features may be added and/or deleted from the subset. Wrapper methods include, for example, forward feature selection, backward feature elimination, recursive feature elimination, combinations thereof, and the like. For example, forward feature selection may be used to identify one or more candidate feature groups. Forward feature selection is an iterative method that begins with no features. In each iteration, the feature which best improves the model is added until an addition of a new variable does not improve the performance of the model. As another example, backward elimination may be used to identify one or more candidate feature groups. Backward elimination is an iterative method that begins with all features in the model. In each iteration, the least significant feature is removed until no improvement is observed on removal of features. Recursive feature elimination may be used to identify one or more candidate feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to the absolute value of the magnitude of coefficients and ridge regression performs L2 regularization which adds a penalty equivalent to the square of the magnitude of coefficients.

After the training module 1020 has generated a feature set(s), the training module 1020 may generate the prediction models 1040A-1040N based on the feature set(s). A machine-learning-based prediction model (e.g., any of the prediction models 1040A-1040N) may refer to a complex mathematical model for the prediction of customer churn, fraud detection, demand forecasting, or other business outcomes through automated machine learning processes. The complex mathematical model for the prediction may be generated using machine-learning techniques as described herein. For example, a machine-learning-based iterative learning control model may repeat one or more AutoML experiments/scenarios. The training module 1020 may use the feature sets extracted from the first training dataset 1010A and/or the second training dataset 1010B to build the prediction models 1040A-1040N. In some examples, the prediction models 1040A-1040N may be combined into a single prediction model 1030 (e.g., an ensemble model). Similarly, the prediction model 1030 may represent a single model containing a single or a plurality of prediction models 1040A-1040N and/or multiple models containing a single or a plurality of prediction models 1040A-1040N (e.g., an ensemble model).

The extracted features (e.g., one or more candidate features) may be combined in the prediction models 1040A-1040N that are trained using a machine-learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting prediction model 1030 may comprise a decision rule or a mapping for each candidate feature in order to assign a prediction to a class.

FIG. 10B is a flowchart illustrating an example training method 1050 for generating the prediction model 1030 using the training module 1020. The training module 1020 may implement supervised, unsupervised, and/or semi-supervised (e.g., reinforcement based) learning. The method 1050 illustrated in FIG. 10B is an example of a supervised learning method; variations of this example of training method may be analogously implemented to train unsupervised and/or semi-supervised machine-learning models. The method 1050 may be implemented by one or more devices/components of the system 100 or the system 150, or another computing device in communication therewith via wired or wireless communication.

At step 1051, the training method 1050 may determine (e.g., access, receive, retrieve, etc.) first training data and second training data (e.g., the training datasets 1010A-1010B). The first training data and the second training data may each comprise one or more labeled data. The one more labeled data may comprise one or more inputs (e.g., input features) and corresponding known outputs associated with the one or more inputs. Using the churn example, the one or more labeled data of the training data may comprise customer demographic information, service usage patterns, billing history, contract details, payment methods, and historical churn indicators for automated machine learning experiments.

The training method 1050 may generate, at step 1052, a training dataset and a testing dataset. The training dataset and the testing dataset may be generated by randomly assigning data from the first training data and/or the second training data to either the training dataset or the testing dataset. In some implementations, the assignment of data as training or test data may not be completely random. For example, the training dataset and/or the testing dataset may be generated based on temporal splits to ensure model validation reflects real-world deployment scenarios where predictions are made on future data.

The training method 1050 may determine (e.g., extract, select, etc.), at step 1053, a set of features from the first training data. As another example, the training method 1050 may determine a set of features from the second training data. The training method 1050 may train one or more machine-learning models (e.g., one or more classification models, one or more prediction models, neural networks, deep-learning models, etc.) using the one or more features at step 1054. In one example, the machine-learning models may be trained using supervised learning. In another example, other machine-learning techniques may be used, including unsupervised learning and semi-supervised. The machine-learning models trained at step 1054 may be selected based on different criteria depending on the problem to be solved and/or data available in the training dataset. For example, machine-learning models may suffer from different degrees of bias. Accordingly, more than one machine-learning model may be trained at step 1054, and then optimized, improved, and cross-validated at step 1055.

The training method 1050 may select one or more machine-learning models to build the prediction model 1030 at step 1056. The prediction model 1030 may be evaluated using the testing dataset. The prediction model 1030 may analyze the testing dataset and generate predicted values at step 1057. Classification and/or prediction values may be evaluated at step 1058 to determine whether such values have achieved a desired accuracy level. Performance of the prediction model 1030 may be evaluated in a number of ways based on a number of true positives, false positives, true negatives, and/or false negatives classifications of the plurality of data points indicated by the prediction model 1030. Generally, recall refers to a ratio of true positives to a sum of true positives and false negatives, which quantifies a sensitivity of the prediction model 1030. Similarly, precision refers to a ratio of true positives to a sum of true and false positives. When such a desired accuracy level is reached, the training phase ends and the prediction model 1030 may be output at step 1059; when the desired accuracy level is not reached, however, then a subsequent iteration of the training method 1050 may be performed starting at step 1051 with variations such as, for example, considering a larger collection of labeled data. The prediction model 1030 may be output at step 1059. The present methods and systems may be computer-implemented.

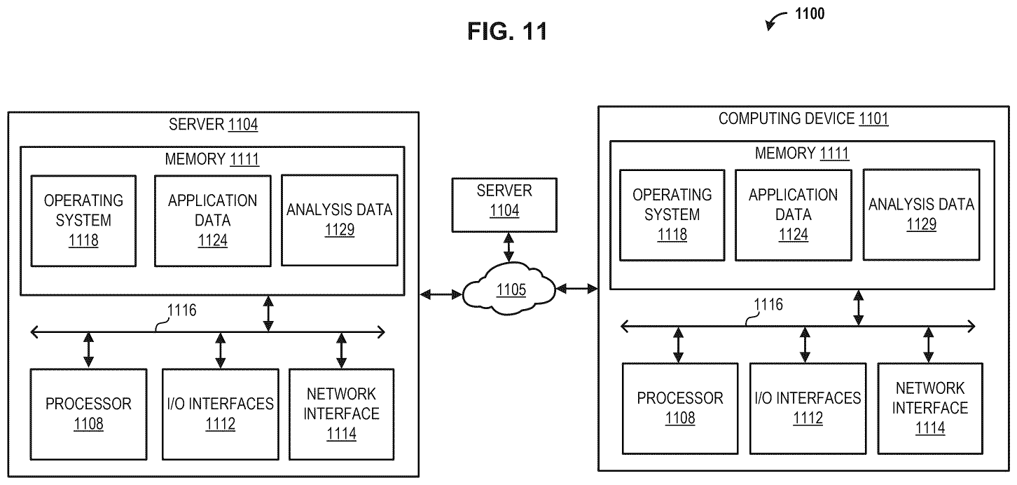

FIG. 11 shows a block diagram depicting a system/environment 1100 comprising non-limiting examples of a computing device 1101 and a server 1102 connected through a network 1105. Either of the computing device 1101 or the server 1102 may be a computing device, such as any of the devices of the system 100 shown in FIG. 1A. In an aspect, some or all steps of any described method may be performed on a computing device as described herein. The computing device 1101 may comprise one or multiple computers configured to store analysis data 1129, and/or the like. The server 1102 may comprise one or multiple computers configured to store application data 1124. Multiple servers 1102 may communicate with the computing device 1101 via the through the network 1105.

The computing device 1101 and the server 1102 may be a digital computer that, in terms of hardware architecture, generally includes a processor 1108, system memory 1111, input/output (I/O) interfaces 1112, and network interfaces 1114. These components (1108, 1110, 1112, and 1114) are communicatively coupled via a local interface 1116. The local interface 1116 may be, for example, but not limited to, one or more buses or other wired or wireless connections, as is known in the art. The local interface 1116 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1108 may be a hardware device for executing software, particularly that stored in system memory 1111. The processor 1108 may be any custom made or commercially available processor, a central processing unit (CPU), an auxiliary processor among several processors associated with the computing device 1101 and the server 1102, a semiconductor-based microprocessor (in the form of a microchip or chip set), or generally any device for executing software instructions. When the computing device 1101 and/or the server 1102 is in operation, the processor 1108 may execute software stored within the system memory 1111, to communicate data to and from the system memory 1111, and to generally control operations of the computing device 1101 and the server 1102 pursuant to the software.

The I/O interfaces 1112 may be used to receive user input from, and/or for providing system output to, one or more devices or components. User input may be provided via, for example, a keyboard and/or a mouse. System output may be provided via a display device and a printer (not shown). I/O interfaces 1112 may include, for example, a serial port, a parallel port, a Small Computer System Interface (SCSI), an infrared (IR) interface, a radio frequency (RF) interface, and/or a universal serial bus (USB) interface.

The network interface 1114 may be used to transmit and receive from the computing device 1101 and/or the server 1102 on the network 1105. The network interface 1114 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 1114 may include address, control, and/or data connections to enable appropriate communications on the network 1105.

The system memory 1110 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 1110 may incorporate electronic, magnetic, optical, and/or other types of storage media. Note that the system memory 1110 may have a distributed architecture, where various components are situated remote from one another, but may be accessed by the processor 1108.

The software in system memory 1110 may include one or more software programs, each of which comprises an ordered listing of executable instructions for implementing logical functions. In the example of FIG. 11, the software in the system memory 1110 of the computing device 1101 may comprise the analysis data 1129, the application data 1124, and a suitable operating system (O/S) 1118. In the example of FIG. 11, the software in the system memory 1110 of the server 1102 may comprise the analysis data 1129, the application data 1124, and a suitable operating system (O/S) 1118. The operating system 1118 essentially controls the execution of other computer programs and provides scheduling, input-output control, file and data management, memory management, and communication control and related services.

For purposes of illustration, application programs and other executable program components such as the operating system 1118 are shown herein as discrete blocks, although it is recognized that such programs and components may reside at various times in different storage components of the computing device 1101 and/or the server 1102. An implementation of the system/environment 1100 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

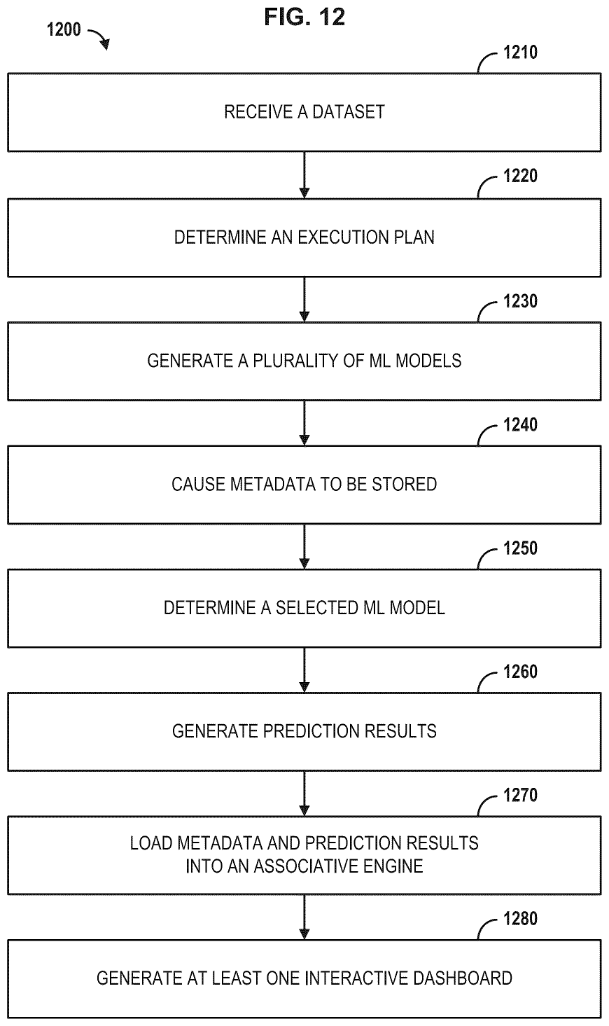

FIG. 12 illustrates a method 1200 for integrating automated machine learning with associative analytics to enable contextual metadata analysis and interactive model exploration. The method 1200 may provide a comprehensive workflow for transforming static machine learning outputs into dynamic, explorable analytical environments. The method 1200 may be applied to various analytical domains including customer churn prediction, fraud detection, demand forecasting, and risk assessment.

The method 1200 begins with a step 1210 where a dataset may be received for processing. The step 1210 may involve data ingestion from various sources including databases, file systems, or cloud storage platforms. In some cases, the dataset may undergo initial validation and preprocessing during the step 1210 to ensure data quality and compatibility with subsequent processing stages. Following data reception, the method 1200 proceeds to a step 1220 where an execution plan for the automated machine learning workflow may be determined. The step 1220 may involve analyzing dataset characteristics such as size, feature types, and target variable properties to select appropriate preprocessing techniques and modeling algorithms. In some cases, the step 1220 may establish computational resource allocation and processing timelines based on dataset complexity and available system capacity. The execution plan may incorporate exploratory data analysis similar to the interface shown in FIG. 4, where features can be reviewed and configured before model training.

The method 1200 continues to a step 1230 where a plurality of machine learning models may be generated through automated training processes. The step 1230 may implement multiple algorithmic approaches including decision trees, ensemble methods, neural networks, and gradient boosting techniques. In some cases, the step 1230 may perform hyperparameter optimization and cross-validation for each candidate model to maximize predictive performance. The model generation process may follow the workflow illustrated in FIG. 2, where training step 210, training step 212, and training step 214 capture the model training, metadata generation, and storage phases.

During model generation, the method 1200 advances to a step 1240 where metadata may be stored throughout the training process. The step 1240 may capture comprehensive information including feature selection decisions, preprocessing transformations, algorithm parameters, training durations, and performance metrics. In some cases, the step 1240 may record intermediate training states and validation scores to enable detailed analysis of model development progression. The metadata storage may correspond to training step 214 shown in FIG. 2, where training metadata is stored within database and file store systems.

The method 1200 then proceeds to a step 1250 where a selected machine learning model may be determined from the plurality of generated models based on performance criteria. The step 1250 may evaluate models using metrics such as accuracy, precision, recall, F1-score, or area under the curve depending on the prediction task type. In some cases, the step 1250 may apply business-specific criteria or constraints to model selection beyond pure statistical performance measures. The model selection process may result in performance displays similar to those shown in FIG. 5, where metrics 502 present accuracy, precision, recall, and F1-score values.

After model selection, the method 1200 continues to a step 1260 where prediction results may be generated using the selected model on the dataset. The step 1260 may produce individual predictions for each data record along with confidence scores or probability estimates. In some cases, the step 1260 may generate explanation data such as SHAP values or feature importance scores to provide interpretability for each prediction outcome. This process may align with inference step 220 and inference step 222 shown in FIG. 2, where predictions are generated and performance metadata is created. The prediction results may be displayed in formats similar to predictions 504 in FIG. 5, showing confusion matrix values for classification accuracy.

The method 1200 then advances to a step 1270 where metadata and prediction results may be loaded into an associative engine for interactive analysis. The step 1270 may transform model outputs into structured data tables suitable for associative processing. In some cases, the step 1270 may establish relationships between prediction results, explanation data, and original dataset features to enable cross-dimensional exploration. This loading process may correspond to analysis step 232 and analysis step 234 shown in FIG. 2, where model metadata is loaded into the analytics engine for in-memory processing. The associative engine may enable the interactive analysis capabilities demonstrated in FIG. 7, where multiple scatter plots allow exploration of relationships between features.

The method 1200 concludes with a step 1280 where at least one interactive dashboard may be generated to enable users to explore model results through associative analytics capabilities. The step 1280 may instantiate templated visualizations including performance metrics displays, feature importance charts, prediction distribution plots, and scenario analysis interfaces. In some cases, the step 1280 may configure dashboard components to respond dynamically to user selections and filters applied through the associative engine. The dashboard generation may follow the pattern shown in analysis step 238 and analysis step 239 in FIG. 2, where dashboard metadata is loaded and user analysis is enabled. The resulting dashboards may include interfaces similar to those shown in FIG. 6 for scenario optimization, FIG. 8 for what-if parameter analysis, and FIG. 9 for comprehensive model overview.

The method 1200 may enable seamless integration between automated model development and interactive analytical exploration. In some cases, the method 1200 may support iterative refinement where insights gained through associative analysis may inform subsequent model training cycles. The method 1200 may facilitate collaborative workflows where data scientists and business analysts may interact with model results using familiar analytical interfaces rather than specialized machine learning tools. The interactive capabilities may support real-time scenario analysis as demonstrated in FIG. 8, where parameter adjustments can immediately update visualizations.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, based on a user selection, a dataset for a machine learning experiment;
determining, based on the selected dataset, an execution plan for the machine learning experiment;
generating, based on the execution plan, a plurality of machine learning models through automated model training;
causing, based on completion of the automated model training, metadata associated with the plurality of machine learning models to be stored in a database;
determining, based on performance metrics, a selected model from the plurality of machine learning models;
generating, based on the selected model, prediction results and explanation data comprising SHAP values;
causing, based on a user request for analysis, the metadata and prediction results to be loaded into an associative engine for in-memory processing; and
generating, based on the loaded data in the associative engine, an interactive dashboard comprising visualizations that update dynamically in response to user selections.

2. The method of claim 1, wherein the metadata comprises at least one of model performance metrics, feature importance data, hyperparameters, preprocessing steps, or training configurations.

3. The method of claim 1, wherein the explanation data comprises SHAP values calculated for each feature contribution to individual predictions.

4. The method of claim 1, wherein the interactive dashboard comprises at least one of confusion matrices, feature importance charts, prediction distribution visualizations, or what-if scenario analysis controls.

5. The method of claim 1, further comprising:
generating, based on user input through the interactive dashboard, modified scenario parameters; and
causing, based on the modified scenario parameters, updated predictions to be displayed in real-time.

6. The method of claim 1, wherein the associative engine processes user selections to filter the metadata and prediction results instantaneously without requiring server queries.

7. The method of claim 1, wherein the execution plan comprises selecting algorithms from at least one of linear-based algorithms, tree-based algorithms, neural networks, or ensemble methods.

8. A non-transitory computer-readable medium storing instructions that, when executed by a processor, cause the processor to perform operations comprising:
receiving, based on a user selection, a dataset for a machine learning experiment;
determining, based on the selected dataset, an execution plan for the machine learning experiment;
generating, based on the execution plan, a plurality of machine learning models through automated model training;
causing, based on completion of the automated model training, metadata associated with the plurality of machine learning models to be stored in a database;
determining, based on performance metrics, a selected model from the plurality of machine learning models;
generating, based on the selected model, prediction results and explanation data comprising SHAP values;
causing, based on a user request for analysis, the metadata and prediction results to be loaded into an associative engine for in-memory processing; and
generating, based on the loaded data in the associative engine, an interactive dashboard comprising visualizations that update dynamically in response to user selections.

9. The non-transitory computer-readable medium of claim 8, wherein the metadata comprises at least one of model performance metrics, feature importance data, hyperparameters, preprocessing steps, or training configurations.

10. The non-transitory computer-readable medium of claim 8, wherein the explanation data comprises SHAP values calculated for each feature contribution to individual predictions.

11. The non-transitory computer-readable medium of claim 8, wherein the interactive dashboard comprises at least one of confusion matrices, feature importance charts, prediction distribution visualizations, or what-if scenario analysis controls.

12. The non-transitory computer-readable medium of claim 8, wherein the operations further comprise:
generating, based on user input through the interactive dashboard, modified scenario parameters; and
causing, based on the modified scenario parameters, updated predictions to be displayed in real-time.

13. The non-transitory computer-readable medium of claim 8, wherein the associative engine processes user selections to filter the metadata and prediction results instantaneously without requiring server queries.

14. An apparatus comprising:
a processor; and
a memory storing instructions that, when executed by the processor, cause the apparatus to:
receive, based on a user selection, a dataset for a machine learning experiment;
determine, based on the selected dataset, an execution plan for the machine learning experiment;
generate, based on the execution plan, a plurality of machine learning models through automated model training;
cause, based on completion of the automated model training, metadata associated with the plurality of machine learning models to be stored in a database;
determine, based on performance metrics, a selected model from the plurality of machine learning models;
generate, based on the selected model, prediction results and explanation data comprising SHAP values;
cause, based on a user request for analysis, the metadata and prediction results to be loaded into an associative engine for in-memory processing; and
generate, based on the loaded data in the associative engine, an interactive dashboard comprising visualizations that update dynamically in response to user selections.

15. The apparatus of claim 14, wherein the metadata comprises at least one of model performance metrics, feature importance data, hyperparameters, preprocessing steps, or training configurations.

16. The apparatus of claim 14, wherein the explanation data comprises SHAP values calculated for each feature contribution to individual predictions.

17. The apparatus of claim 14, wherein the interactive dashboard comprises at least one of confusion matrices, feature importance charts, prediction distribution visualizations, or what-if scenario analysis controls.

18. The apparatus of claim 14, wherein the instructions further cause the apparatus to:
generate, based on user input through the interactive dashboard, modified scenario parameters; and
cause, based on the modified scenario parameters, updated predictions to be displayed in real-time.

19. The apparatus of claim 14, wherein the associative engine processes user selections to filter the metadata and prediction results instantaneously without requiring server queries.

20. The apparatus of claim 14, wherein the execution plan comprises selecting algorithms from at least one of linear-based algorithms, tree-based algorithms, neural networks, or ensemble methods.
